(19) United States
(12) Patent Application Publication
(10) Pub. No.: US 2023/0375410 A1
(43) Pub. Date: Nov. 23, 2023

(54) APPARATUSES AND SYSTEMS FOR OPTICAL ELEMENT MEASUREMENTS

(71) Applicant: Facebook Technologies, LLC, Menlo Park, CA (US)

(72) Inventors: Aiqing Chen, Fremont, CA (US); Chandra Sekhar Kakani, Fremont, CA (US); Evan Michael Pollard, Fremont, CA (US); Ashvath Sharma, Cupertino, CA (US)

(21) Appl. No.: 17/749,410

(22) Filed: May 20, 2022

(51) Int. Cl. G01J 4/00

(52) U.S. Cl. CPC G01J 4/00; G01J 2004/002

(57) ABSTRACT

The disclosed apparatus may include a holding affordance that is configured to hold an optical element, a beam emitter, and a beam sensor, where the holding affordance is positioned, along a first dimension, between the beam emitter and the beam sensor; a first linear stage that supports the beam emitter and that, when actuated, moves the beam emitter along a second dimension; a first rotational stage that supports the beam emitter and that, when actuated, rotates the beam emitter in a staging plane defined by the first dimension and the second dimension; a second linear stage that supports the beam sensor and that, when actuated, moves the beam sensor along the second dimension; and a second rotational stage that supports the beam sensor and that, when actuated, rotates the beam sensor in the staging plane. Various other systems and methods are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of an example apparatus for optical element measurements.

FIG. 2 is a diagram of an example optical element measurement.

FIG. 3 is a diagram of an example optical element measurement.

FIG. 4 is a diagram of an example optical element measurement.

FIG. 5 is a diagram of an example optical element measurement.

FIG. 6 is an illustration of an example apparatus for holding an optical element.

FIG. 7 is an illustration of an example mount for an optical element.

FIG. 8 is a reverse view of the example mount of FIG. 7.

FIG. 9 is an illustration of an assembly of the mount of FIG. 7 coupled to apparatus of FIG. 6.

FIG. 10 is a reverse view of the assembly of FIG. 9.

FIG. 11 is a diagram of an example polar array for measuring an optical element.

FIG. 12 is an illustration of example measurements of an optical element.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Modern optical elements may be incorporated into applications that depend on consistent and precise optical properties. Manufacturing processes for some optical elements may use complex and sensitive equipment that takes close calibration to achieve the desired product. Accordingly, the ability to quickly, inexpensively, precisely, and accurately measure the optical properties of an optical element can be valuable for calibrating, testing, and quality control in manufacturing optical elements. However, measuring optical properties of an optical element can be challenging; in particular, where the optical element has a curved surface and alters the path of a beam used to make measurements.

The present disclosure is generally directed to apparatuses and systems for measuring properties of optical elements. As will be explained in greater detail below, in some examples an apparatus may include a holding affordance for an optical element to be tested as well as an emitter and a sensor to opposite sides of the optical element. The emitter may emit a beam through the optical element, which may be received by the sensor. The sensor may be positioned at the appropriate position and angle to receive the beam, given the path that the ray is expected to take through the optical element. The emitter and the sensor may each be actuated to rotate and to move linearly in order to test different parts of the optical element (and, e.g., via different angles of incidence). In some examples, sample points tested may form a radial grid to approximate full coverage of the optical element. The holding affordance for the optical element may rotate such that various points around the optical element are tested as the emitter and the sensor remain in a fixed position. The holding affordance may be equipped with magnets, allowing optical elements to quickly be removed from and inserted into the apparatus without requiring other reconfigurations. The apparatus may provide comprehensive and precise testing for a variety of elements with optical power, including lens assemblies, optical films, etc. The apparatus may detect polarization properties such as transmission axis and transmission intensity.

By providing linear movement and rotation for both emitter and sensor, the apparatuses and systems described herein may be able to fully and precisely measure optical elements with varying curvatures and that induce varying beam paths, including performing measurements using beams with varying angles of incidence applied to the optical element. Thus, these apparatuses and systems may quickly, flexibly, comprehensively, and precisely measure properties of optical elements. Accordingly, these apparatuses and systems represent an improvement in the testing and manufacture of optical elements.

Features from any of the embodiments described herein may be used in combination with one another in accordance with the general principles described herein. These and other embodiments, features, and advantages will be more fully understood upon reading the following detailed description in conjunction with the accompanying drawings and claims.

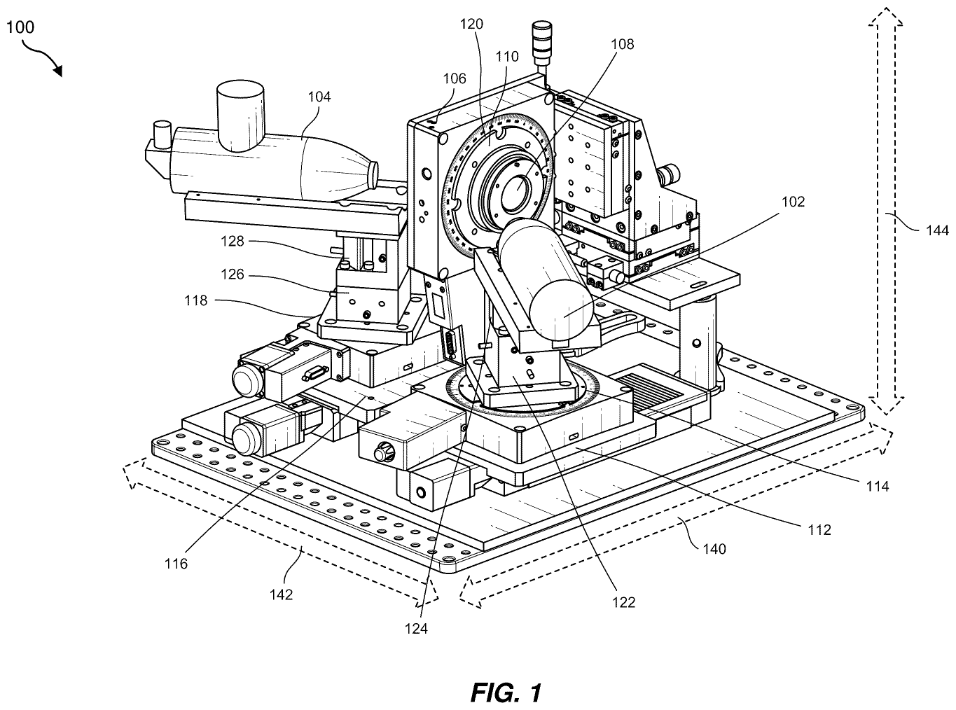

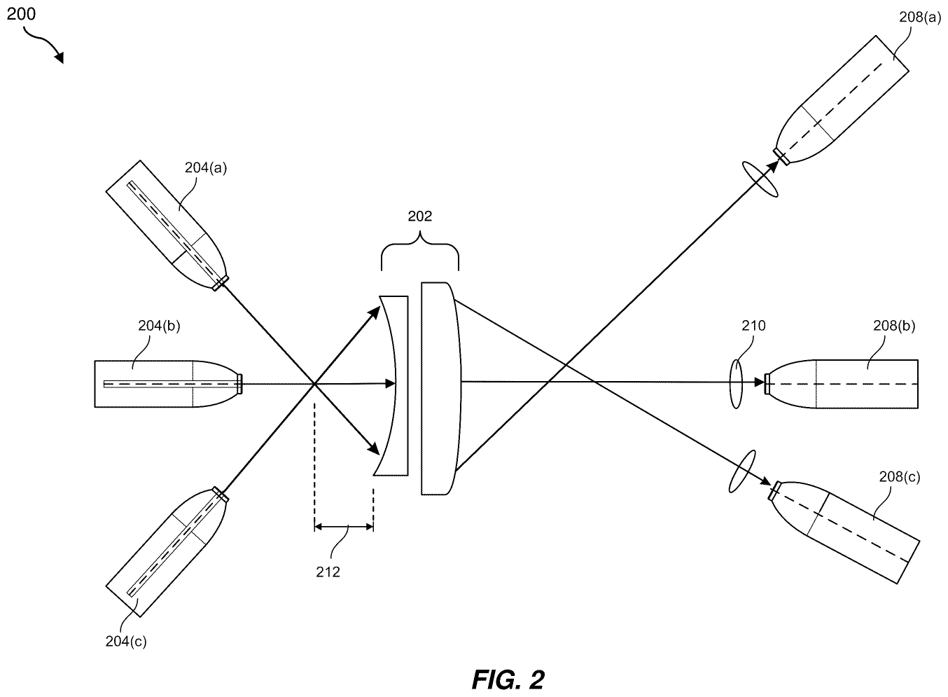

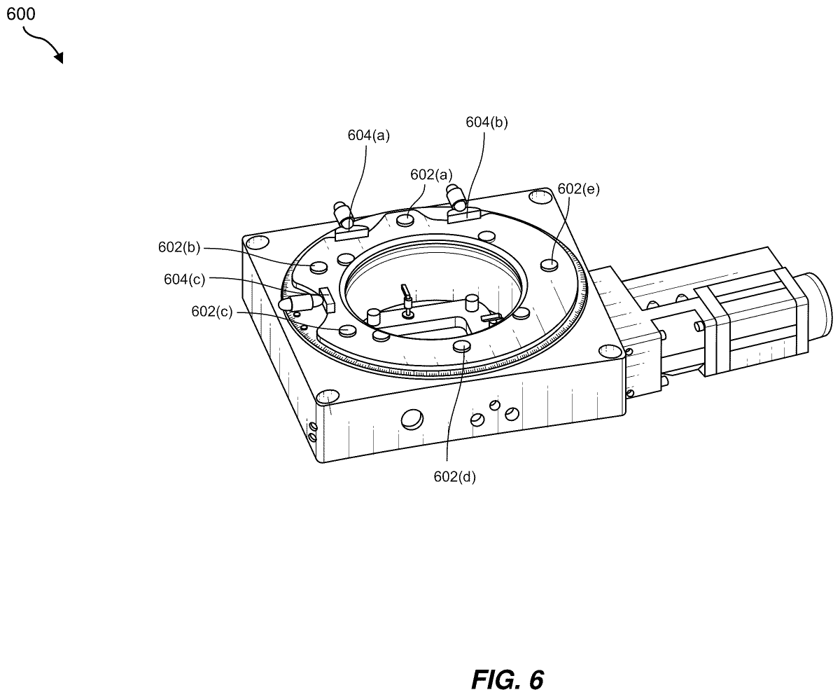

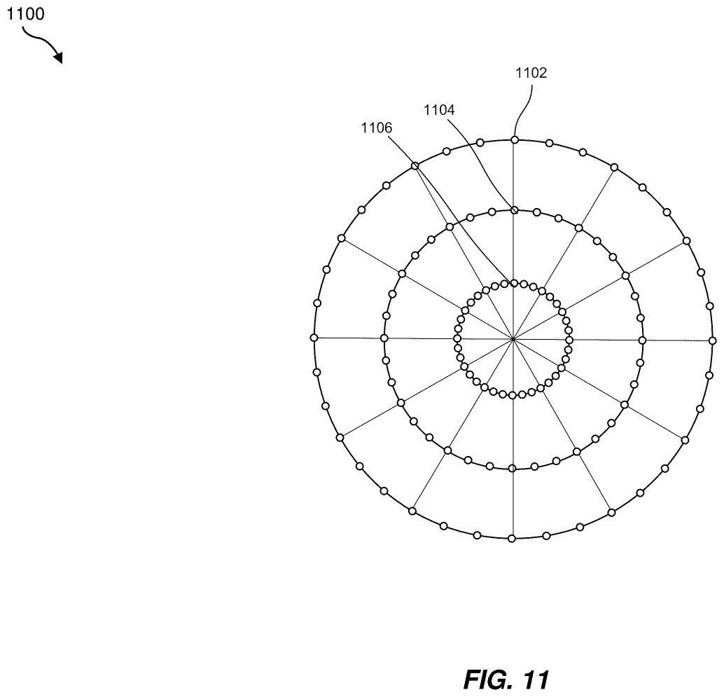

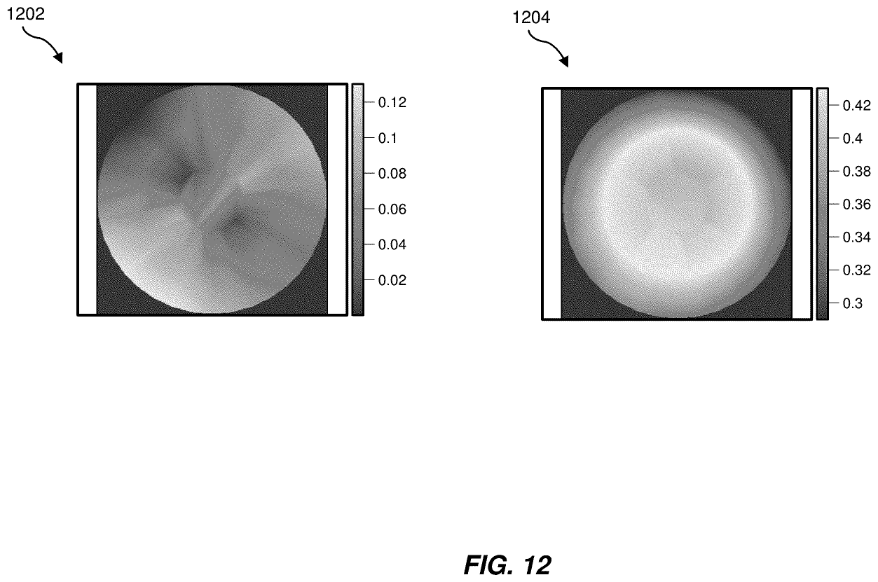

The following will provide, with reference to FIG. 1, detailed descriptions of an example apparatus for optical element measurements; with reference to FIGS. 2-5, detailed descriptions of example optical element measurements; with reference to FIGS. 6-10, detailed descriptions of a holding affordance and mount for an optical element; with reference to FIG. 11, detailed descriptions of an example polar array for measuring an optical element; and, with reference to FIG. 12, detailed descriptions of example measurements of an optical element.

FIG. 1 is an illustration of an example apparatus 100 for optical element measurements. As shown in FIG. 1, apparatus may include a beam emitter 102, a beam sensor 104, and a holding affordance 106. Holding affordance 106 may be adapted to hold an optical element 108. In some examples, holding affordance 106 may hold optical element 108 by holding a mount, such as a mount 110, in which optical element 108 is mounted.

The beam emitter 102 may include any type of electromagnetic radiation emitter and/or illuminator that may emit electromagnetic radiation suitable for testing one or more optical properties of an optical element. In some examples, the beam emitter 102 may include a polarization state generator. In some examples, the polarization state generator may produce a beam of electromagnetic radiation (e.g., light) with a specified polarization state. For example, the polarization state generator may produce linearly polarized light, elliptically polarized light, and/or circularly polarized light. In some examples, the polarization state generator may produce a beam of light with any polarization state specifiable by a stokes vector. Thus, for example, the polarization state generator may produce a beam of light polarized with a specified ellipticity and/or orientation. The beam emitter 102 may produce electromagnetic radiation of any suitable wavelengths. In some examples, the beam emitter 102 may produce any specified wavelength of visible light.

The beam sensor 104 may include any type of electromagnetic radiation sensor and/or collector that may sense one or more properties of electromagnetic radiation suitable for testing one or more optical properties of an optical element. In some examples, the beam sensor 104 may include a polarization state analyzer. In some examples, the polarization state analyzer may collect a beam of electromagnetic radiation (e.g., light) and identify the polarization state of the beam. For example, the polarization state analyzer may identify linearly polarized light, elliptically polarized light, and/or circularly polarized light. In some examples, the polarization state analyzer may identify any polarization state of a beam of light specifiable by a stokes vector. Thus, for example, the polarization state analyzer may determine that the beam of light is polarized with a specified ellipticity and/or orientation. The beam sensor 104 may detect electromagnetic radiation of any suitable wavelengths. In some examples, the beam sensor 104 may detect any wavelength of visible light.

Holding affordance 106 may hold optical element 108 in any suitable manner. As shown in FIG. 1, in some examples holding affordance 106 may hold optical element 108 in between beam emitter 102 and beam sensor 104. For example, as will be described in greater detail below, FIG. 1 shows beam emitter 102 and beam sensor 104 in linearly shifted and rotated states. However, when beam emitter 102 and beam sensor 104 are in their respective neutral positions, they may be in a line with optical element 108, such that a beam emitted by beam emitter 102 would pass straight through the center of optical element 108 and into beam sensor 104 if optical element had no optical properties (e.g., such as to change the path of the beam).

In some examples, holding affordance 106 may hold optical element 108 by holding a mount 110 which, in turn, holds optical element 108. In some examples, mount 110 may be detachable from holding affordance 106. For example, mount 110 may be quickly swappable (e.g., for another mount). In some examples, as will be described in greater detail below, mount 110 may attach to holding affordance 106 magnetically (e.g., holding affordance 106 may have one or more magnets that attract one or more magnets on mount 110).

Optical element 108 may represent any optical element with one or more optical properties to measure. In some examples, optical element 108 may represent a lens. In some examples, optical element 108 may represent a simple lens. In other examples, optical element 108 may represent a compound lens or other assembly of simpler optical elements. In some examples, optical element 108 may have a curved surface. In some examples, optical element 108 may include an optical film (i.e., a film with optical properties). In some examples, optical element 108 may include an optical film adhered to a curved surface. Apparatus 100 may measure any of a variety of optical properties of optical element 108. For example, apparatus 100 may measure (and/or be used in conjunction with computing logic to measure) one or more polarization properties of optical element 108 (e.g., of an optical film on a curved surface). In some examples, apparatus 100 may be used to determine, for one or more points of the surface of optical element 108, the Mueller matrices of the points. Additionally or alternatively, apparatus 100 may be used to measure diattenuation, transmittance, transmission axis, fast axis, transmission intensity, and/or retardance magnitude.

In some examples, optical element 108 may include a polarizer film. In some examples, optical element 108 may include a retarder film.

As shown in FIG. 1, a linear stage 112 may support a rotational stage 114, which may, in turn, support beam emitter 102. Linear stage 112 may, when actuated, move laterally with respect to optical element 108 (e.g., along a dimension 142). As linear stage 112 moves laterally, so does rotational stage 114 (and, thus, beam emitter 102). Rotational stage 114 may, when actuated, rotate (e.g., within a staging plane defined by dimension 140 and a dimension 142). As rotational stage 114 rotates, so may beam emitter 102. By actuating linear stage 112 and/or rotational stage 114, beam emitter 102 may emit a beam that reaches the diameter (along dimension 140) of optical element 108 at any point and with a range of angles of incidence.

A linear stage 116 may support a rotational stage 118, which may, in turn, support beam sensor 104. Linear stage 116 may, when actuated, move laterally with respect to optical element 108 (e.g., along dimension 142). As linear stage 116 moves laterally, so does rotational stage 118 (and, thus, beam sensor 104). Rotational stage 118 may, when actuated, rotate (e.g., within the staging plane defined by dimension 140 and dimension 142). As rotational stage 118 rotates, so may beam sensor 104. By actuating linear stage 116 and/or rotational stage 118, beam sensor 104 may receive a beam that has exited optical element 108 from a variety of points and at a variety of angles.

As shown in FIG. 1, holding affordance 106 may include a rotating element 120. Rotating element 120, when actuated, may rotate azimuthally (e.g., within a plane defined by dimension 140 and a dimension 144). As rotating element 120 rotates, so may mount 110 (and, thus, optical element 108). Because, in some examples, beam emitter 102 may direct a beam toward various points along the diameter of optical element 108, by rotating optical element 108, the beam from beam emitter 102 may reach any point of the surface of optical element 108. As will be explained in greater detail below, in some examples the apparatuses and systems described herein may measure optical properties from a polar array of points on the surface of optical element 108 (by, e.g., aiming beam emitter 102 at various distances from the center of optical element 108 and, for each such distance, performing (in steps) a complete rotation of optical element 108.

As shown in FIG. 1, in some examples apparatus 100 may include an adjustment device 122. Adjustment device 122 may allow for relatively small, precise adjustments to the position of beam emitter 102 relative to rotational stage 114. In some examples, adjustment device 122 may allow for adjustments in three dimensions (e.g., small shifts along dimensions 140, 142, and/or 144). Similarly, apparatus 100 may include an adjustment device 126 that may allow for relatively small, precise adjustments to the position of beam sensor 104 relatively to rotational stage 118. In some examples, adjustment device 126 may allow for adjustments in three dimensions (e.g., dimensions 140, 142, and/or 144). Adjustment devices 122 and 126 may allow for apparatus 100 to be finely calibrated to ensure, e.g., that the positions of beam emitter 102 and beam sensor 104, respectively, precisely match their expected and/or logically represented positions. In some examples, adjustment devices 122 and 126 may allow for manual adjustment. Additionally or alternatively, in some examples adjustment devices 122 and 126 may be actuated responsive to a digital signal. In these examples, an automated calibration process (e.g., conducted without optical element 108 in place) may control adjustment devices 122 and 126.

As shown in FIG. 1, apparatus 100 may include a boresight adjustment mechanism 124. Boresight adjustment mechanism 124 may be used to adjust the tilt of beam emitter 102, such that beam emitter 102 emits a beam on a plane defined by dimensions 140 and 142 and passing through the center of optical element 108. Likewise, apparatus 100 may include a boresight adjustment mechanism 128 that may be used to adjust the tilt of beam sensor 104, such that beam sensor 104 is aligned to receive a beam on the plane defined by dimensions 140 and 142 and passing through the center of optical element 108. In some examples, boresight adjustment mechanisms 124 and 128 may allow for manual adjustment. Additionally or alternatively, in some examples boresight adjustment mechanisms 124 and 128 may be actuated responsive to a digital signal. In these examples, an automated calibration process (e.g., conducted without optical element 108 in place) may control boresight adjustment mechanisms 124 and 128.

FIG. 2 is a diagram of an example operation 200 of an apparatus for measuring optical properties. As shown in FIG. 2, an apparatus for optical element measurements (e.g., apparatus 100 of FIG. 1) may measure one or more optical properties of an optical element 202. Thus, for example, one or more hardware and/or software modules may identify a part of optical element 202 to measure, test, and/or analyze (and, e.g., an angle of incidence with which to test the part of optical element 202). These modules may then linearly shift and rotate a beam emitter (such as beam emitter 102 of FIG. 1) into a position 204(a) in order to direct the beam to the targeted part (and with, e.g., the specified angle of incidence). Based on a model of optical element 202 (e.g., using ray tracing data), one or more hardware and/or software modules may linearly shift and rotate a beam sensor (such as bean sensor 104 of FIG. 1) into a position 208(a) to receive the beam.

The systems described herein may also test other parts of optical element 202. For example, the above-described modules may linearly shift and rotate the beam emitter into a position 204(b) and, based on a model of optical element 202, linearly shift and rotate the beam sensor into a position 208(b). Similarly, the modules may linearly shift and rotate the beam emitter into a position 204(c) and linearly shift and rotate the sensor into a position 208(c).

In some examples, as shown in FIG. 2, the beam sensor may include a converging lens 210 placed in front to focus the incoming beam to a smaller spot. In addition, as shown in FIG. 2, in some examples the beam emitter may be set at a distance from the optical element to determine an effective working distance 212 of the optical system. In some examples, effective working distance 212 may be set based on the application of the optical element. For example, the optical element may be a lens (and/or an optical film on a lens) for an augmented reality and/or virtual reality head-mounted display. Accordingly, effective working distance 212 may be in the range of approximately 15 millimeters to approximately 22 millimeters. In other examples, effective working distance 212 may be in the range of approximately 10 millimeters to approximately 30 millimeters, approximately 7 millimeters to approximately 35 millimeters, or approximately, or approximately 5 millimeters to approximately 50 millimeters.

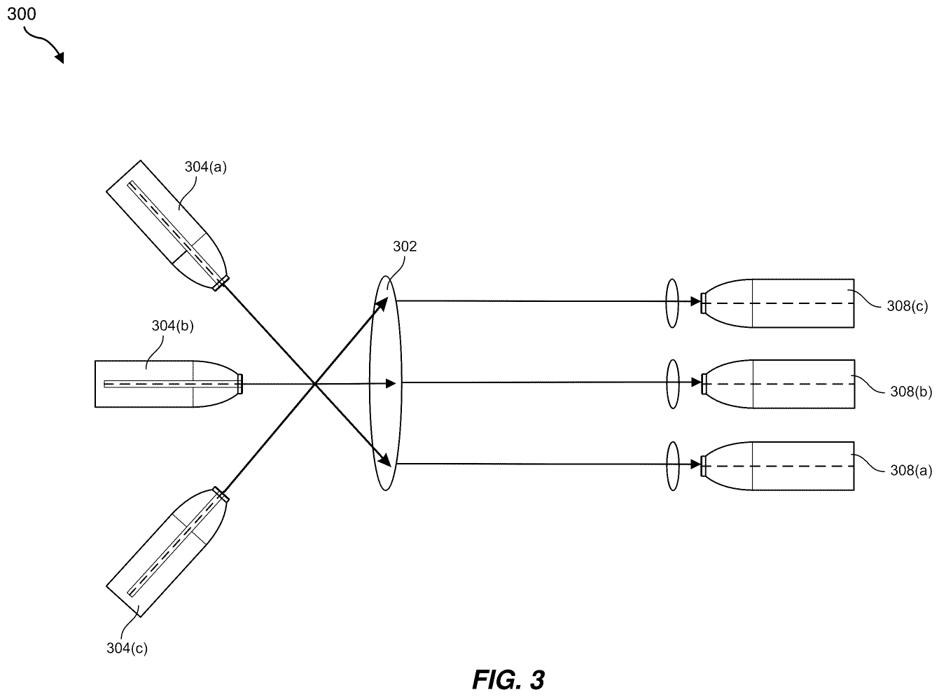

FIG. 3 is a diagram of an example optical element measurement 300. As shown in FIG. 3, apparatuses and systems described herein may measure one or more optical properties of various parts of an optical element 302. For example, the beam emitter may emit a beam from a position 304(a) and the beam sensor may collect the beam at a position 308(a). Likewise, the beam emitter may emit a beam from a position 304(b) and the beam sensor may collect the beam at a position 308(b). In addition, the beam emitter may emit a beam from a position 304(c) and the beam sensor may collect the beam at a position 308(c). As may be appreciated, in this example, an apparatus may shift and rotate the beam emitter and may shift without rotating the beam sensor.

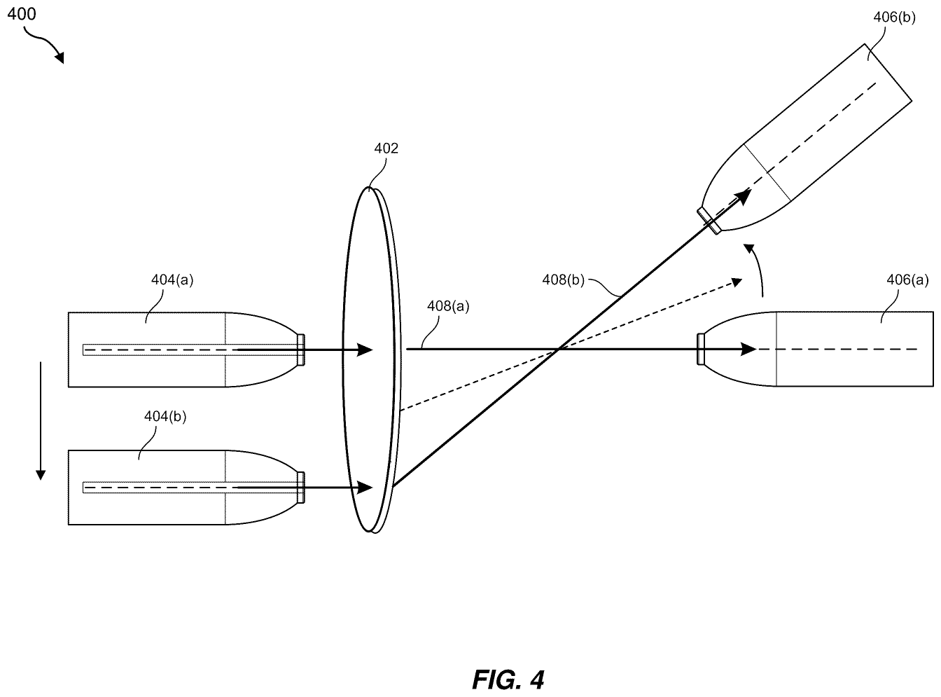

FIG. 4 is a diagram of an example optical element measurement 400. As shown in FIG. 4, apparatuses and systems described herein may measure one or more optical properties of various parts of an optical element 402. For example, the beam emitter may emit a beam from a range of positions starting at a position 404(a) to a position 404(b), generating beams starting from a path 408(a) to a path 408(b), which beams may be collected by the beam sensor in a range of positions starting at a position 406(a) to a position 406(b).

Furthermore, as will be explained in greater detail below, at each position (including various intermediate positions not pictured), apparatuses and systems described herein may rotate optical element 402, taking periodic measurements. In this manner, the apparatuses and systems described herein may take measurements of the entire optical element 402 (at a specified resolution).

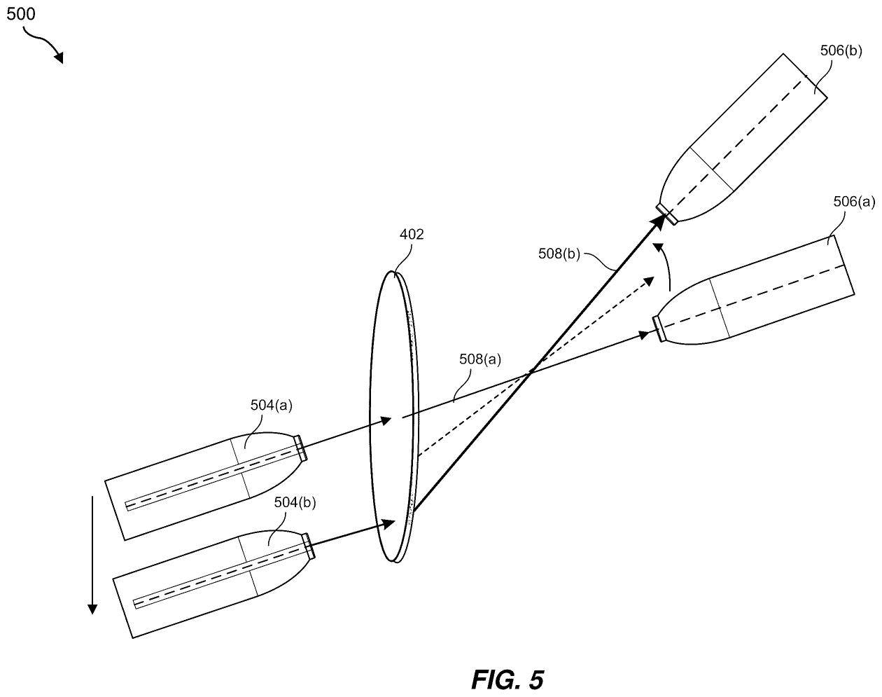

FIG. 5 is a diagram of an example optical element measurement 500. As shown in FIG. 5, apparatuses and systems described herein may measure one or more optical properties of various parts of optical element 402 from an angle of incidence different from that shown in FIG. 4. For example, the beam emitter may emit a beam from a range of positions starting at a position 504(a) to a position 504(b), generating beams starting from a path 508(a) to a path 508(b), which beams may be collected by the beam sensor in a range of positions starting at a position 506(a) to a position 506(b).

FIG. 6 is an illustration of an example apparatus 600 for holding an optical element. As shown in FIG. 6, apparatus 600 may include magnets 602(a)-(e) for attaching and detaching a mount. This may allow quick swapping of one mount (with one optical element) for another mount (with another optical element), or for quickly removing the mount, swapping the optical element from the mount, and reattaching the mount. Apparatus 600 may also include anchors 604(a)-(c) which, as will be explained in greater detail below, may enable positional adjustments of the optical element.

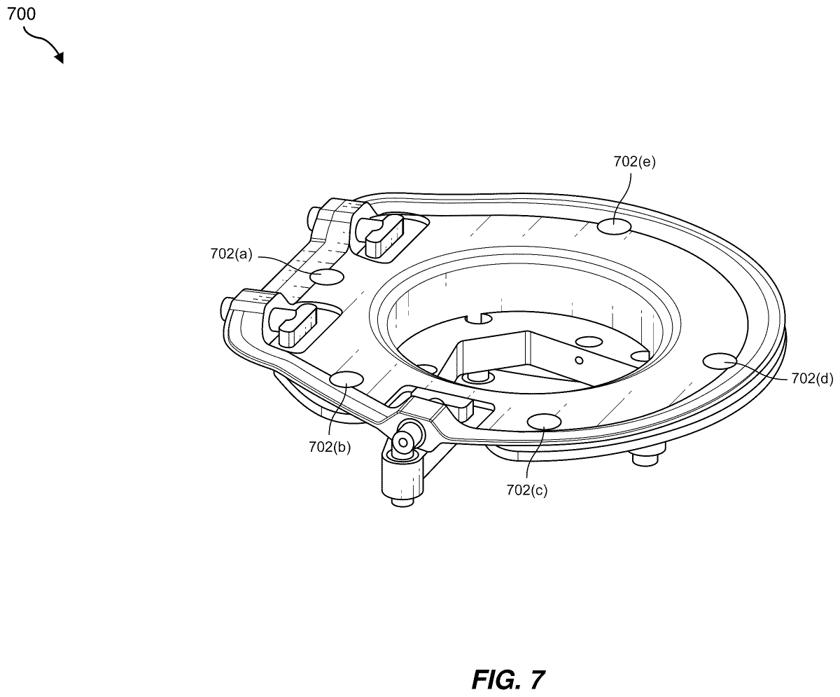

FIG. 7 is an illustration of an example mount 700 for an optical element. As shown in FIG. 7, mount 700 may include magnets 702(a)-(e) for coupling mount 700 to apparatus 600 (e.g., by coupling magnets 702(a)-(e) to magnets 602(a)-(e), respectively.

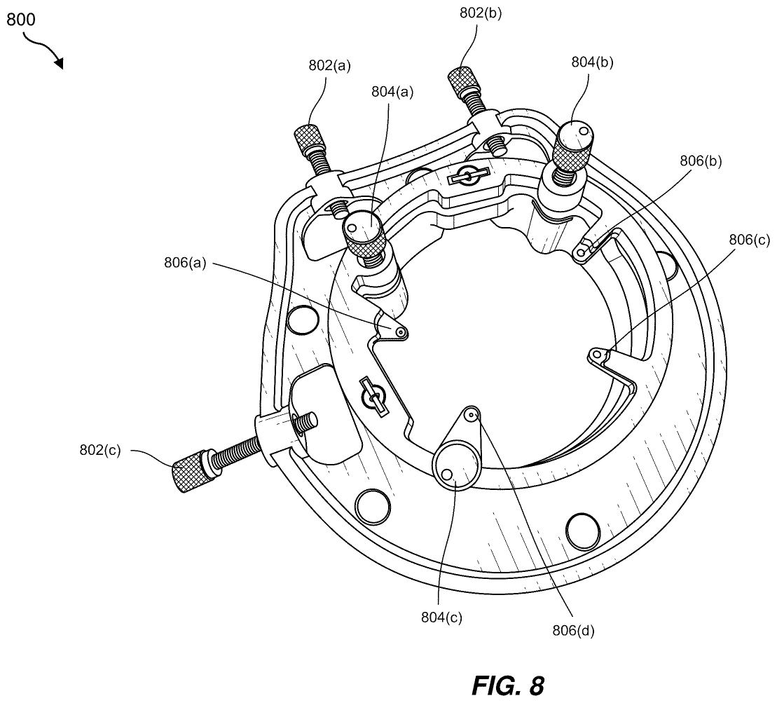

FIG. 8 is an illustration of a mount 800. As shown in FIG. 8, mount 800 may include affordances 802(a)-(c) for adjusting the centering of the optical element with respect to apparatus 600. For example, affordances 802(a)-(c) may hold mount 800 at adjustable distances from anchors 604(a)-(c), respectively, thereby adjusting the position of the optical element. In addition, mount 800 may include affordances 804(a)-(c) for adjusting the tilt of the optical element with respect to apparatus 600. For example, affordances 804(a)-(c) may hold corresponding parts of mount 800 at adjustable distances from apparatus 600, thereby adjusting the tilt of mount 800 relative to apparatus 600.

Mount 800 may also include mounting points 806(a)-(d) for attaching an optical element to mount 800. In various examples, a frame of the optical element may be screwed onto mounting points 806(a)-(d). In other examples, mounting points 806(a)-(d) may clamp onto a frame of the optical element and/or snap together with the frame of the optical element.

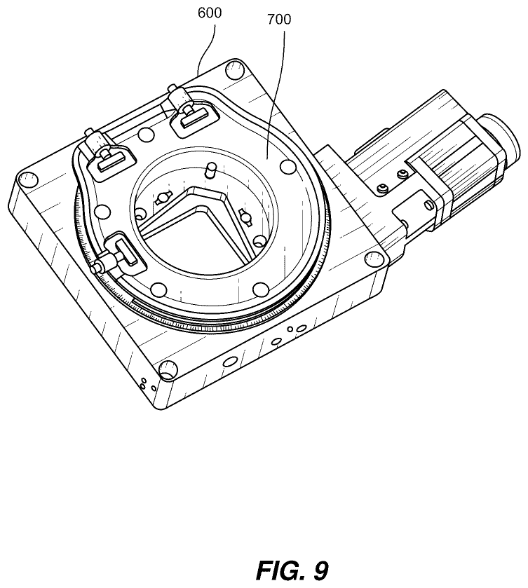

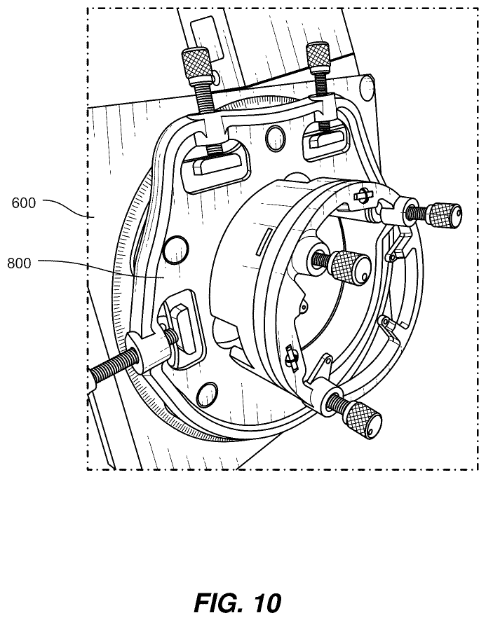

FIG. 9 is an illustration of an assembly of the mount of FIG. 7 coupled to apparatus 600 of FIG. 6. As shown in FIG. 9, mount 700 may be magnetically coupled to apparatus 600. FIG. 10 is an illustration of an assembly of the mount of FIG. 8 coupled to apparatus 600 of FIG. 6. As shown in FIG. 10, mount 800 may be magnetically coupled to apparatus 600.

FIG. 11 is a diagram of an example polar array 1100 for measuring an optical element. As discussed earlier, in order to measure optical properties at various points of an optical element, systems and apparatuses described herein may direct a beam at various points along the radius of the surface of the optical element and then rotate the optical element, periodically taking measurements at points in a circle as the optical element rotates. Thus, for example, systems and apparatuses described herein may position a beam emitter to direct a beam at a point 1102 (and may position a beam sensor to collect the beam, accounting for the projected beam path based on the optical element). After taking a measurement at point 1102, the systems and apparatuses described herein may rotate the optical element in increments (e.g., 5 degrees at a time) and take measurements at each increment.

After completing the rotation of the optical element, these systems and apparatuses may position the beam emitter to direct a beam at a point 1104 (and reposition the beam sensor to collect the beam). After taking a measurement at point 1104, these systems and apparatuses may again rotate the optical element and take measurements (e.g., in 5 degree increments). These systems and methods may then repeat the process starting at a point 1106, taking measurements while rotating the optical element in increments. It may be appreciated that these systems and apparatuses may thereby provide effectively full coverage in measuring the optical properties of the optical element, and may improve the resolution of the measurements by reducing the size of the increments along the radius (e.g., sampling at more than the three distances along the radius pictured in FIG. 11) and/or by reducing the size of the angle increments when rotating the optical element. While FIG. 11 illustrates using the same angle increment regardless of the distance from the center, in some examples the systems and apparatuses described herein may use greater angle increments closer to the center and smaller angle increments further from the center in order to achieve a roughly equal density of measurements across the surface of the optical element.

In some examples, systems described herein may control the actuation of the apparatus for measuring optical properties to achieve coverage of measurement of the optical element. For example, one or more modules may identify a model of the optical element that describes, estimates, and/or predicts beam paths through the optical element (e.g., with ray tracing data that accounts for possible locations and angles of incidence) to determine the locations and angles of exit of beams. These modules may then transmit emitter-staging parameters to actuate the linear and rotational stages of the beam emitter to a position and orientation for testing a specified point (and, in some examples, angle of incidence) of the optical element. Based on the model of the optical element, these modules may also transmit sensor-staging parameters to actuate the linear and rotational stages of the beam emitter to a position and orientation for collecting the beam. Furthermore, these modules may transmit signals to actuate rotation of the optical element.

The systems described herein may also record measurements performed by the beam sensor in association with the positions and orientations of the beam emitter and/or the beam sensor, as well as the azimuthal rotation of the optical element. In this manner, and as will be described in greater detail below, these systems may reconstruct a map or distribution of measurements across the surface of the optical element based on an aggregate of the individual measurements taken.

FIG. 12 is an illustration of example measurements of an optical element. As shown in FIG. 12, a measurement 1202 may show a transmission axis distribution across the surface of a lens. A measurement 1204 may show a transmittance intensity, retardance magnitude and orientation, diattenuation magnitude and orientation, polarizance magnitude and orientation, and/or ellipticity distribution across the lens surface. As can be appreciated from the depiction of measurements 1202 and 1204, the systems and apparatuses described herein may provide a high-resolution and comprehensive measurement of polarization properties of the surface of a curved optical element.

### EXAMPLE EMBODIMENTS

Example 1: An apparatus may include a holding affordance that is configured to hold an optical element, a beam emitter, and a beam sensor, where the holding affordance is positioned along a first dimension, between the beam emitter and the beam sensor; a first linear stage that supports the beam emitter and that, when actuated, moves the beam emitter along a second dimension; a first rotational stage that supports the beam emitter and that, when actuated, rotates the beam emitter in a staging plane defined by the first dimension and the second dimension; a second linear stage that supports the beam sensor and that, when actuated, moves the beam sensor along the second dimension; and a second rotational stage that supports the beam sensor and that, when actuated, rotates the beam sensor in the staging plane.

Example 2: The apparatus of Example 1, where the beam emitter includes a polarization state generator.

Example 3: The apparatus of any of Examples 1 and 2, where the beam sensor includes a polarization state analyzer.

Example 4: The apparatus of any of Examples 1-3, where the optical element includes a lens.

Example 5: The apparatus of any of Examples 1-4, where the holding affordance is further configured to rotate the optical element azimuthally.

Example 6: The apparatus of any of Examples 1-5, where the holding affordance is configured to hold the optical element by holding, via at least one magnet, a magnetic mount that holds the optical element.

Example 7: A system including that apparatus of Example 1; at least one physical processor; and physical memory including computer-executable instructions that, when executed by the physical processor, cause the physical processor to (1) transmit emitter-staging parameters to the first linear stage and first rotational stage to actuate to a first position and a first orientation, respectively; and (2) transmit sensor-staging parameters to the second linear stage and second rotational stage to actuate to a second position and a second orientation, respectively.

Example 8: The system of Example 7, where the beam emitter includes a polarization state generator.

Example 9: The system of any of Examples 7 and 8, where the beam sensor includes a polarization state analyzer.

Example 10: The system of any of Examples 7-9, where the optical element includes a lens.

Example 11: The system of any of Examples 7-10, where the holding affordance is further configured to rotate the optical element azimuthally.

Example 12: The system of any of Examples 7-11, further including transmitting one or more instructions to the holding affordance to rotate the optical element while the first and second linear stages and the first and second rotational stages remain in place.

Example 13: The system of any of Examples 7-12, where the holding affordance is configured to hold the optical element by holding, via at least one magnet, a magnetic mount that holds the optical element.

Example 14: The system of any of Examples 7-13, further including determining the sensor-staging parameters based at least in part on the emitter-staging parameters.

Example 15: The system of any of Examples 7-14, further including recording a measurement from the beam sensor in association with the first position, first orientation, second position, and second orientation.

Example 16: The system of any of Examples 7-15, where the measurement is further recorded in association with an azimuthal rotation of the optical element.

Example 17: The system of any of Examples 7-16, where recording the measurement from the beam sensor includes recording at least one of: a transmission axis, a fast axis, a transmission intensity, or a retardance magnitude.

Example 18: The system of any of Examples 7-17, further including generating a map of an optical property of the optical element based on a plurality of measurements recorded in association with a plurality of positions and orientations of the first and second linear stages and the first and second rotational stages, the plurality of measurements including the measurement from the beam sensor in association with the first position, first orientation, second position, and second orientation.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive ray tracing data to be transformed, transform the ray tracing data, output a result of the transformation to control a measurement apparatus, use the result of the transformation to measure optical properties of an optical element, and store the result of the transformation to create a map of optical properties of the optical element. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An apparatus comprising:
a holding affordance that is configured to hold an optical element,
a beam emitter, and
a beam sensor,
wherein the holding affordance is positioned, along a first dimension, between the beam emitter and the beam sensor;
a first linear stage that supports the beam emitter and that, when actuated, moves the beam emitter along a second dimension;
a first rotational stage that supports the beam emitter and that, when actuated, rotates the beam emitter in a staging plane defined by the first dimension and the second dimension;
a second linear stage that supports the beam sensor and that, when actuated, moves the beam sensor along the second dimension; and
a second rotational stage that supports the beam sensor and that, when actuated, rotates the beam sensor in the staging plane.

2. The apparatus of claim 1, wherein the beam emitter comprises a polarization state generator.

3. The apparatus of claim 1, wherein the beam sensor comprises a polarization state analyzer.

4. The apparatus of claim 1, wherein the optical element comprises a lens.

5. The apparatus of claim 1, wherein the holding affordance is further configured to rotate the optical element azimuthally.

6. The apparatus of claim 1, wherein the holding affordance is configured to hold the optical element by holding, via at least one magnet, a magnetic mount that holds the optical element.

7. A system comprising:
a holding affordance that is configured to hold an optical element,
a beam emitter, and
a beam sensor,
wherein the holding affordance is positioned, along a first dimension, between the beam emitter and the beam sensor;
a first linear stage that supports the beam emitter and that, when actuated, moves the beam emitter along a second dimension;
a first rotational stage that supports the beam emitter and that, when actuated, rotates the beam emitter in a staging plane defined by the first dimension and the second dimension;
a second linear stage that supports the beam sensor and that, when actuated, moves the beam sensor along the second dimension;
a second rotational stage that supports the beam sensor and that, when actuated, rotates the beam sensor in the staging plane;
at least one physical processor; and
physical memory comprising computer-executable instructions that, when executed by the physical processor, cause the physical processor to:
transmit emitter-staging parameters to the first linear stage and first rotational stage to actuate to a first position and a first orientation, respectively; and
transmit sensor-staging parameters to the second linear stage and second rotational stage to actuate to a second position and a second orientation, respectively.

8. The system of claim 7, wherein the beam emitter comprises a polarization state generator.

9. The system of claim 7, wherein the beam sensor comprises a polarization state analyzer.

10. The system of claim 7, wherein the optical element comprises a lens.

11. The system of claim 7, wherein the holding affordance is further configured to rotate the optical element azimuthally.

12. The system of claim 11, wherein the computer-executable instructions further cause the computing device to transmit one or more instructions to the holding affordance to rotate the optical element while the first and second linear stages and the first and second rotational stages remain in place.

13. The system of claim 7, wherein the holding affordance is configured to hold the optical element by holding, via at least one magnet, a magnetic mount that holds the optical element.

14. The system of claim 7, wherein the computer-executable instructions further cause the computing device to determine the sensor-staging parameters based at least in part on the emitter-staging parameters.

15. The system of claim 7, wherein the computer-executable instructions further cause the computing device to record a measurement from the beam sensor in association with the first position, first orientation, second position, and second orientation.

16. The system of claim 15, where the measurement is further recorded in association with an azimuthal rotation of the optical element.

17. The system of claim 15, wherein recording the measurement from the beam sensor comprises recording at least one of:
a transmission axis;
a fast axis;
a transmission intensity; or
a retardance magnitude.

18. The system of claim 15, further wherein the computer-executable instructions further cause the computing device to generate a map of an optical property of the optical element based on a plurality of measurements recorded in association with a plurality of positions and orientations of the first and second linear stages and the first and second rotational stages, the plurality of measurements comprising the measurement from the beam sensor in association with the first position, first orientation, second position, and second orientation.

19. A computer-implemented method, comprising:
identifying an apparatus comprising:
a holding affordance that is configured to hold an optical element,
a beam emitter, and
a beam sensor,
wherein the holding affordance is positioned, along a first dimension, between the beam emitter and the beam sensor;
a first linear stage that supports the beam emitter and that, when actuated, moves the beam emitter along a second dimension;
a first rotational stage that supports the beam emitter and that, when actuated, rotates the beam emitter in a staging plane defined by the first dimension and the second dimension;
a second linear stage that supports the beam sensor and that, when actuated, moves the beam sensor along the second dimension; and
a second rotational stage that supports the beam sensor and that, when actuated, rotates the beam sensor in the staging plane;
transmitting emitter-staging parameters to the first linear stage and first rotational stage to actuate to a first position and a first orientation, respectively; and
transmitting sensor-staging parameters to the second linear stage and second rotational stage to actuate to a second position and a second orientation, respectively.

20. The computer-implemented method of claim 19, further comprising recording a measurement from the beam sensor in association with the first position, first orientation, second position, and second orientation.
